(19) United States
(12) Patent Application Publication
(10) Pub. No.: US 2024/0190354 A1
(43) Pub. Date: Jun. 13, 2024

(54) SPLIT EDGE CARGO NET

(71) Applicants: Hyundai Motor Company, Seoul (KR); Kia Corporation, Seoul (KR)

(72) Inventors: Scott Ziolek, Ann Arbor, MI (US); Joson J. Liburn, Superior Townshi, MI (US)

(21) Appl. No.: 18/076,659

(22) Filed: Dec. 7, 2022

(51) Int. Cl. B60R 7/00

(52) U.S. Cl. CPC B60R 7/005

(57) ABSTRACT

Provided is splitable cargo net. The cargo net includes a flexible netting surrounded by a perimeter cord or band. The flexible netting includes 1) a top section substantially vertically divided into a left top section and a right top section, thereby creating split edges for each of the left top section and the right top section at a location where the sections are divided; 2) a bottom section; and 3) a centerline cord that runs the cargo net substantially horizontally between the top section and the bottom section. Alternatively, the flexible netting is substantially vertically divided into a left section and a right section, thereby creating split edges for each of the left section and the right section at a location where the sections are divided; and the left section and the right section are connected by a connecting part of the perimeter cord or band that runs substantially perpendicularly to the split edges.

### BACKGROUND

### Technical Field

Embodiments of the present disclosure relate to a split edge cargo net.

### Background

Consumers have demanded cargo management flexibility for a variety of different load cases. Also, autonomous vehicle technologies will likely increase the demand for more reconfigurable features. Cargo nets having been used as a barrier, cover, or envelope are fairly common to secure items; however, focus has been primarily on creating tension in the net or a single continuous surface net that can be stretched over cargo or folded into a cargo securing envelope configurations.

In contrast, little attention has been given to increasing the utility, particularly in terms of user flexibility for placing a cargo net envelope. Traditional cargo nets are not transformative, reshapable nor reconfigurable and thus are difficult to removably attach to fixed or movable features within the cargo space.

The matters described in this background section are intended to promote an understanding of the background of the disclosure and may include matters that are not already known to those of ordinary skill in the art.

### SUMMARY

The purpose and advantages of the present invention will be set forth in and apparent from the description that follows, as well as will be learned by practice of the invention. Additional advantages of the invention may be realized or obtained by the methods and systems particularly pointed out in the written description and claims hereof, as well as from the appended drawings.

It may be an object of embodiments of the disclosure to provide a cargo net that is transformative and reshapable. The cargo net is removably attachable to fixed or movable features within the cargo space, including the backside of a seat(s) or a rear seat(s), and adjacent walls of a vehicle, a vehicle frame in the cargo space. This reconfigurable cargo net is significantly useful particularly when the cargo net is at least partially engaged with a foldable seat. When foldable seats fold, the cargo net engaged with the seats must be capable of reconfiguring itself to prevent the cargo net from being subject to any undesirable distortion or tension. This feature provides a user with flexibility in installing the cargo net in a vehicle, primarily in the cargo space. The cargo net is also advantageous to other existing solutions that would similarly improve cargo net usage because it has a lower unit cost.

An embodiment of the present disclosure provides splitable cargo net. The cargo net may include a flexible netting surrounded by a perimeter cord or band. The flexible netting may include 1) a top section substantially vertically divided into a left top section and a right top section, thereby creating split edges for each of the left top section and the right top section at a location where the sections are divided; 2) a bottom section; and 3) a centerline cord that runs the cargo net substantially horizontally between the top section and the bottom section.

According to an exemplary embodiment, the left top section and the right top section may have primary connectors configured to engage with a vehicle and secondary connectors configured to engage with the vehicle.

According to an exemplary embodiment, at least one of the primary connectors may be in a form of cord configured to engage with the vehicle.

According to an exemplary embodiment, at least one of the secondary connectors may be in a form of button configured to be received by a receiver on the vehicle.

According to an exemplary embodiment, the button may include a post that is configured to be received by a recessed portion of the receiver.

According to an exemplary embodiment, the receiver may be positioned on a back side of a seat in the vehicle or an internal wall of the vehicle.

According to an exemplary embodiment, the left top section, the right top section and the bottom section may have primary connectors at each vertex of the perimeter cord or band, respectively, except vertexes on split edges.

According to an exemplary embodiment, the left top section, the right top section and the bottom section may have secondary connectors at each vertex of the perimeter cord or band, respectively, except vertexes on the centerline cord.

According to an exemplary embodiment, the split edges may be configured to be opened and closed by a zipping mechanism such as a zipper.

According to an exemplary embodiment, the flexible netting may be substantially vertically divided into multiple sections, thereby creating split edges for each of the multiple sections at a location where the sections are divided.

Another embodiment of the present disclosure provides splitable cargo net. The cargo net may include a flexible netting surrounded by a perimeter cord or band. The flexible netting may be substantially vertically divided into a left section and a right section, thereby creating split edges for each of the left section and the right section at a location where the sections are divided. The left section and the right section may be connected by a connecting part of the perimeter cord or band that runs substantially perpendicularly to the split edges.

According to an exemplary embodiment, the connecting part may be attached to a seat in the vehicle or an internal wall of the vehicle.

According to an exemplary embodiment, the left section and the right section may have primary connectors configured to engage with a vehicle, or secondary connectors configured to engage with the vehicle.

According to an exemplary embodiment, at least one of the primary connectors may be in a form of cord configured to engage with the vehicle.

According to an exemplary embodiment, at least one of the secondary connectors may be in a form of button configured to be received by a receiver on the vehicle.

According to an exemplary embodiment, the button may include a post that is configured to be received by a recessed portion of the receiver.

According to an exemplary embodiment, the receiver may be positioned on a back side of a seat in the vehicle or an internal wall of the vehicle.

According to an exemplary embodiment, the left section and the right section may have secondary connectors at each vertex of the perimeter cord or band, respectively, except vertexes on the connecting part.

According to an exemplary embodiment, the split edges may be configured to be opened and closed by a zipping mechanism such as a zipper.

According to an exemplary embodiment, the flexible netting may be substantially vertically divided into multiple sections, thereby creating split edges for each of the multiple sections at a location where the sections are divided.

In another embodiment, vehicles are provided that comprise an apparatus i.e. cargo net as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a split edge cargo net, according to an exemplary embodiment of the present disclosure.

FIGS. 2A-2C depict a mechanism or process of engaging a cargo net with a vehicle, according to an exemplary embodiment of the present disclosure.

FIG. 3 is a vehicle including primary attachment portions and secondary attachment portions, according to an exemplary embodiment of the present disclosure.

FIGS. 4A-4C are a perspective, top, and side view of an exemplary secondary attachment portion (receiver), according to an exemplary embodiment of the present disclosure.

FIGS. 5A-5C are a perspective, top, and side view of an exemplary secondary connector (button), according to an exemplary embodiment of the present disclosure.

FIGS. 6A-6C are side view of assemblies including an exemplary secondary attachment portion (receiver) and an exemplary secondary connector (button).

FIGS. 7A-7B depict a split edge cargo net with a zipping mechanism such as a zipper such as a zipper before and after being zipped.

FIGS. 8A-8D depict various split edge cargo nets with different number of sections, according to an exemplary embodiment of the present disclosure.

FIGS. 9A-9C depict various configurations of a split edge cargo net, according to an exemplary embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order, or sequence of the components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence, or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

As used herein, the term “engages” and its variations refer to the attaching, holding, clamping, gripping, grasping, securing, bringing, or coming together, and/or interlocking of various items and/or components.

As used herein, the term “substantially” and its variations as used herein are a broad term, and are to be given its ordinary and customary meaning to a person of ordinary skill in the art (and is not to be limited to a special or customized meaning), and refer without limitation to being largely but not necessarily wholly that which is specified. Alternatively, the term “substantially” and its variations mean at least 80%, 90% or 95%.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

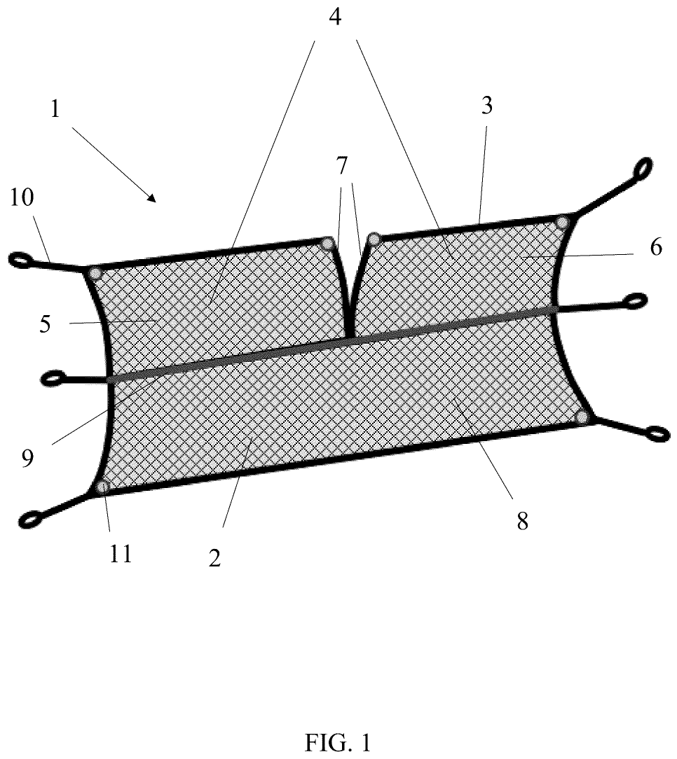

As shown in FIG. 1, a splitable cargo net 1 is provided. The cargo net 1 may include a flexible netting 2 surrounded by a perimeter cord or band 3. Preferably, the perimeter cord or band 3 is flexible. The flexible netting 2 may include 1) a top section 4 substantially vertically divided into a left top section 5 and a right top section 6, thereby creating split edges 7 for each of the left top section 5 and the right top section 6 at a location where the sections 5, 6 are divided; 2) a bottom section 8; and 3) a centerline cord 9 that runs the cargo net 1 substantially horizontally between the top section 5 and the bottom section 8. Each of the sections may rotate independently about the centerline corresponding to fixed or movable features, preferably within the cargo space.

Preferably, the top section 4 is vertically divided into the left top section 5 and the right top section 6. Preferably, the centerline cord 9 runs the cargo net 1 horizontally between the top section 5 and the bottom section 8.

The left top section 5, the right top section 6 and the bottom section 8 may have primary connectors 10 at each vertex of the perimeter cord or band 3, respectively, except vertexes on split edges 7. Alternatively, the left top section 5, the right top section 6 and the bottom section 8 may have primary connectors 10 at some vertexes of the perimeter cord or band 3, respectively, except vertexes on split edges 7. The left top section 5, the right top section 6 and the bottom section 8 may have secondary connectors 11 at each vertex of the perimeter cord or band 3, respectively, except vertexes on the centerline cord. The left top section 5, the right top section 6 and the bottom section 8 may have secondary connectors 11 at some vertexes of the perimeter cord or band 3, respectively, except vertexes on the centerline cord.

The left top section 5 and the right top section 6 may have primary connectors 10 configured to engage with a vehicle (not shown) and/or secondary connectors 11 configured to engage with the vehicle.

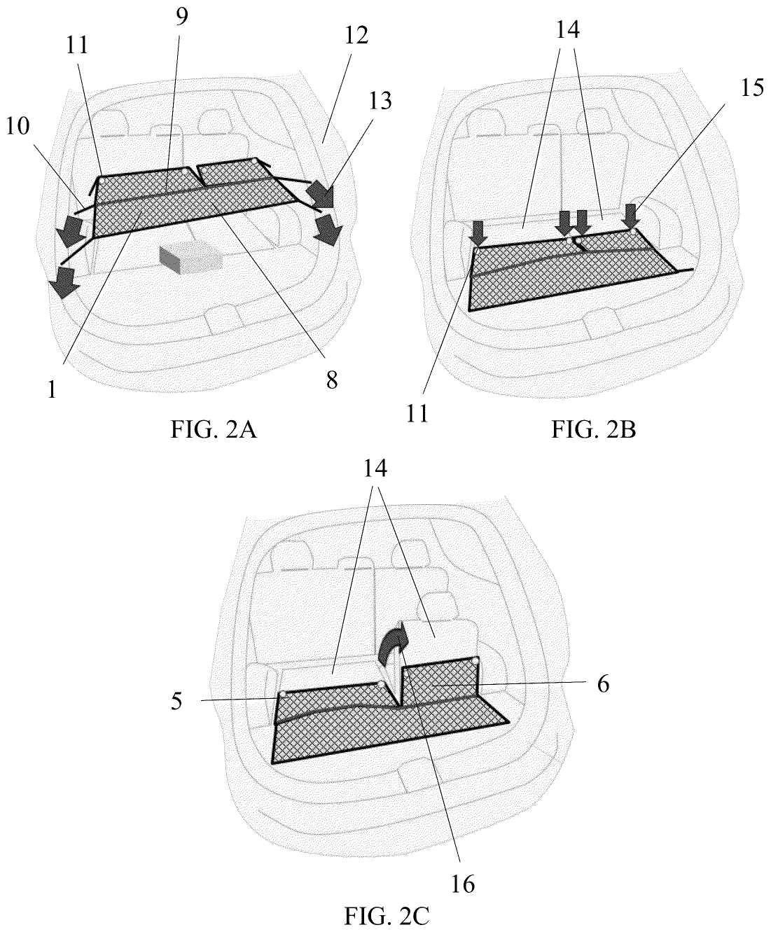

FIGS. 2A-2C depict a mechanism or process of engaging a cargo net 1 with a vehicle 12, particularly at the backside of the rear seats 14, according to an exemplary embodiment of the present disclosure.

As shown in FIG. 2A, the primary connectors 10 connected to the centerline cord 9 and the bottom section 8 of the cargo net 1 may engage with the vehicle 12 at primary attachment portions (not shown) in a direction 13. And, then, as shown in FIG. 2B, the secondary connectors 11 may be engaged with the backside of the rear seats 14 at secondary attachment portions (not shown) in a direction 15. As shown in FIG. 2C, a user may want to put one of the rear seats 14 stowed or upright in a direction 16. This embodiment may create a mix of cargo net cover and a map pocket to secure items. Because the top section 4 is splitted into the left top section 5 and the right top section 6, no undesirable distortion or tension may be created when putting the seat stowed or upright. In other words, the present disclosure provides a cargo net that is easy to use and maintains the cargo net's vehicle attachments while allowing interior features such as the rear seats to adjust to multiple configurations such as seated, reclined, or stowed configurations.

It may be also possible for a user to put the other rear seat 14 such that both of the rear seats 14 are seated stowed or upright. It may be possible to have more than two (e.g., three, four, five, six, etc.) rear seats 14. It may be also possible to engage a splittable cargo net with any seats (e.g., front seats, middle seats, rear seats, etc.).

In FIGS. 2A-2C, each section may provide partitioned cargo nets for items to be placed therein.

At least one of the primary connectors 13 may be in a form of cord configured to engage with the vehicle 12. At least one of the secondary connectors 11 may be in a form of button configured to be received by a second attachment portion 11 such as a receiver on the vehicle 12.

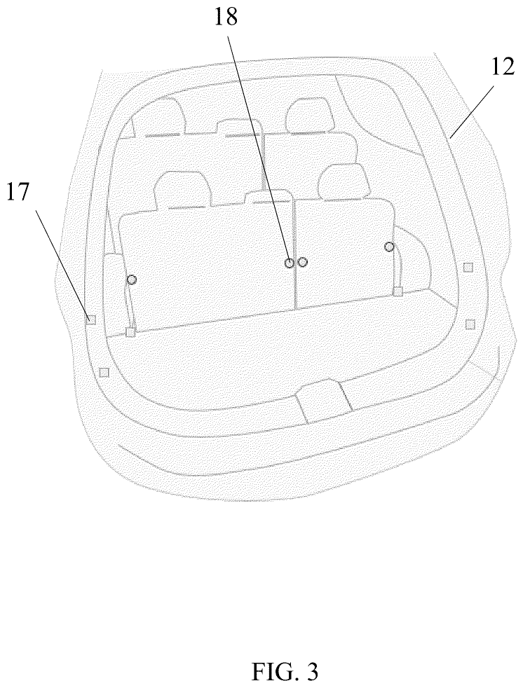

FIG. 3 is a vehicle 12 including primary attachment portions 17 and secondary attachment portions 18, according to an exemplary embodiment of the present disclosure. In this embodiment, there may be six primary attachment portions 17 and four secondary attachment portions. Each side may have three primary attachment portions 17 and two secondary attachment portions 18. It may be possible to have any number of the first and second attachment portions 17 and 18, as long as the cargo net 1 is secured by the attachment portions 17 and 18.

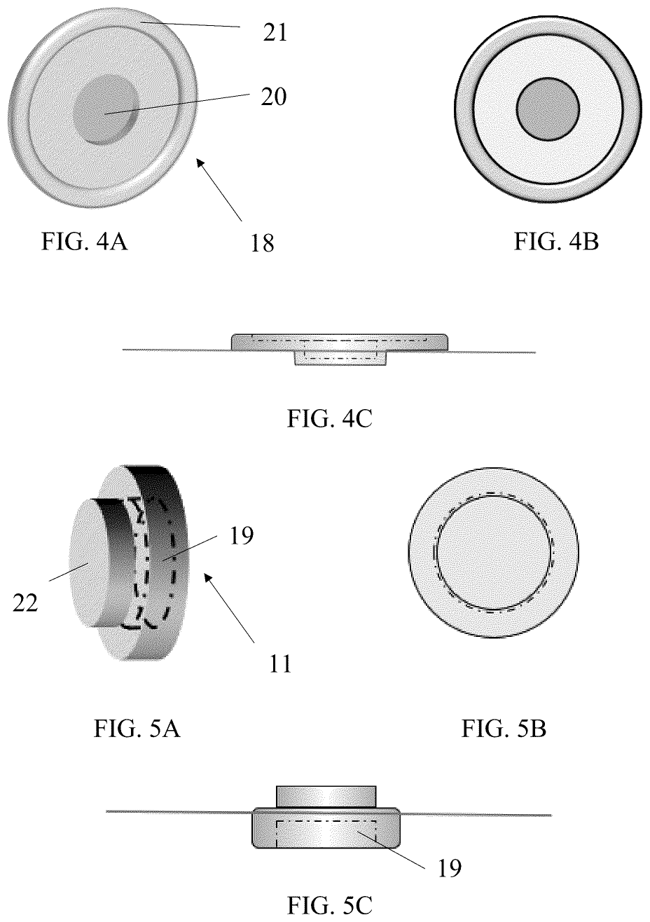

FIGS. 4A-4C are a perspective, top, and side view of an exemplary secondary attachment portion (e.g., receiver) 18, according to an exemplary embodiment of the present disclosure. The receiver 18 may include a recessed portion 20 and/or a reinforced edge 21.

FIGS. 5A-5C are a perspective, top, and side view of an exemplary secondary connector (button) 11, according to an exemplary embodiment of the present disclosure. At least one of the secondary connectors 11 may be in a form of button configured to be received by a receiver 18 on the vehicle 12. The button 11 may include a post 22 that is configured to be received by the recessed portion 20 of the receiver 18, and a socket 19 that is configured to receive another post 22.

The recessed portion 20 and/or a reinforced edge 21 may facilitate the engagement of the secondary connector 11 with the secondary attachment portion 18. While the recessed portion 20, the post 22, and the socket 19 are described to be circular, they may have any suitable shapes and dimensions. At least a part of the secondary connector 11 and the secondary attachment portion 18 may be magnetic to facilitate the engagement with each other.

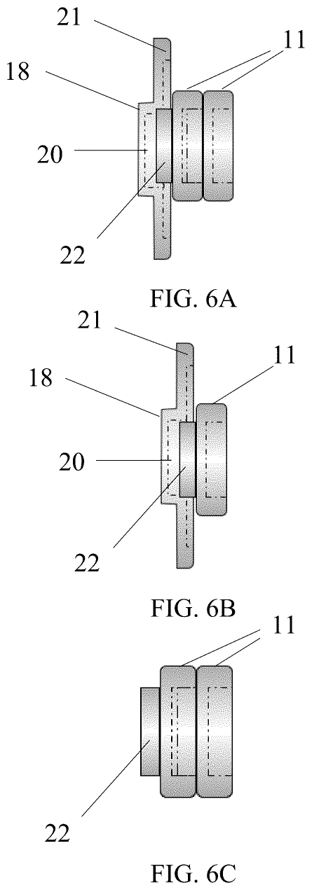

FIGS. 6A-6C are side view of assemblies including an exemplary secondary attachment portion (e.g., receiver) 18 and an exemplary secondary connector (e.g., button) 11. In FIG. 6A, the secondary attachment portion 18 may be to be engaged with the two secondary connectors 11. The two secondary connectors 11 are stacked, as seen from FIG. 6C. If a user pushes the stacked secondary connectors 11 further toward the secondary attachment portion 18, it may complete the assembly. Similarly, in FIG. 6A, the secondary attachment portion 18 may be to be engaged with the one secondary connector 11. The secondary attachment portion (e.g., receiver) 18 may be positioned on a back side of a seat, such as the rear seat 14, in the vehicle 12 or an internal wall (e.g., cargo floor, doors, trim panels, etc.) of the vehicle 12.

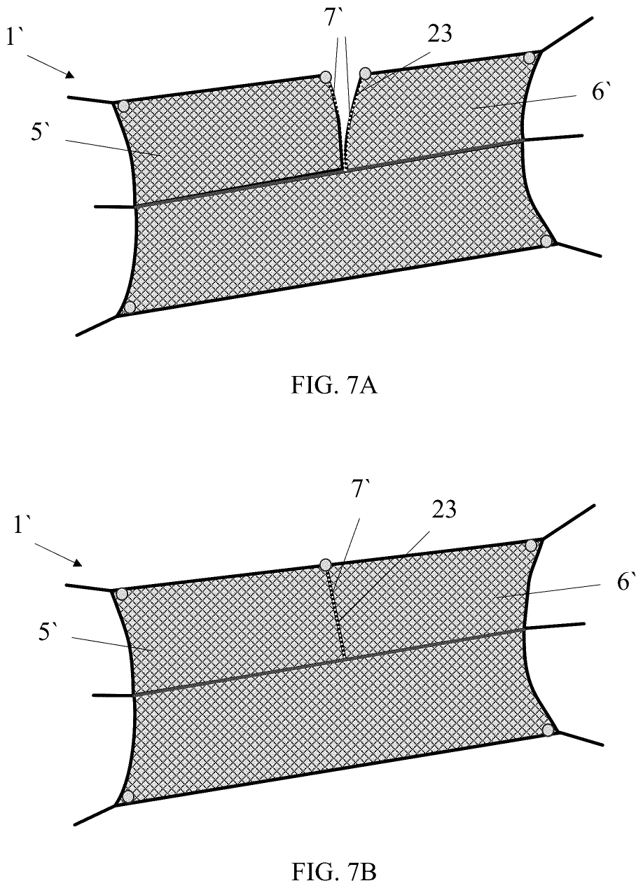

FIGS. 7A-7B depict a split edge cargo net 1′ with a zipping mechanism such as a zipper 23 before and after being zipped. The split edges 7′ may be configured to be opened, as shown in FIG. 7A, and closed, as shown in FIG. 7B, by any suitable zipping mechanism such as a zipper 23. After being zipped, the left top section 5′ and the second top section 6′ may form a single top section so that when engaged with a vehicle, the top single section has undivided internal space.

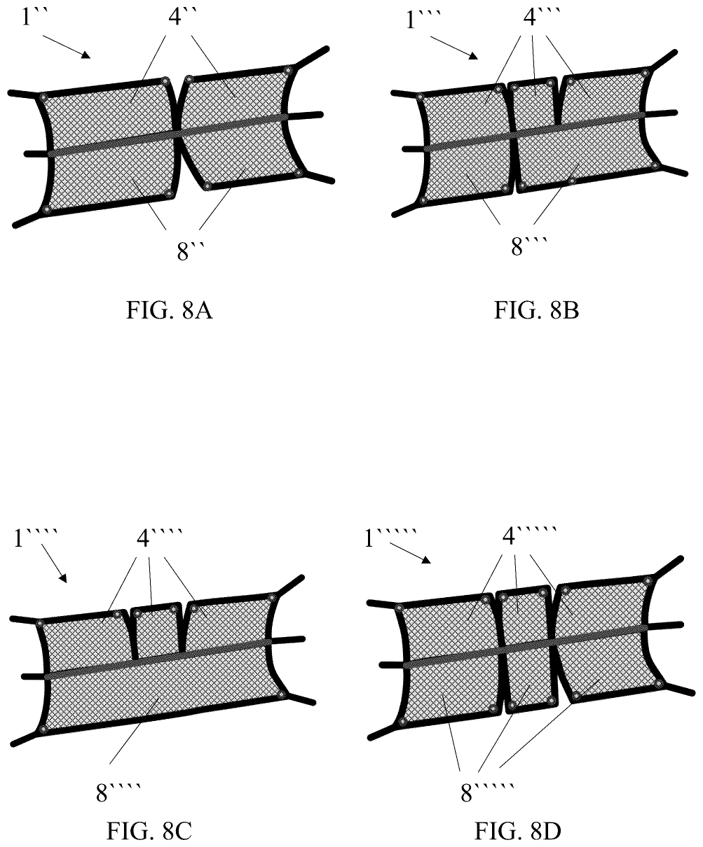

FIGS. 8A-8D depict various split edge cargo nets 1″-1′″″ with different number of sections, according to an exemplary embodiment of the present disclosure. The flexible netting may be substantially vertically divided into multiple sections, thereby creating split edges for each of the multiple sections at a location where the sections are divided. In FIG. 8A, the top section is divided into two sections 4″, and the bottom section is divided into two sections 8″, which creates total four split sections. In FIG. 8B, the top section is divided into three sections 4′″, and the bottom section is divided into two sections 8″, which creates total five split sections. In FIG. 8C, the top section is divided into three sections 4″″, and the bottom section is undivided, which creates total four split sections. In FIG. 8D, the top section is divided into three sections 4′″″, and the bottom section is divided into three sections 8′″″, which creates total six split sections. For each configuration, the sections may have primary connectors at each vertex of the perimeter cord or band, respectively, except vertexes on split edges. The sections may further have secondary connectors at each vertex of the perimeter cord or band, respectively, except vertexes on the centerline cord. Each of the top and bottom sections may have any suitable number of split sections, thereby creating split edges for each of the multiple sections at a location where the sections are divided.

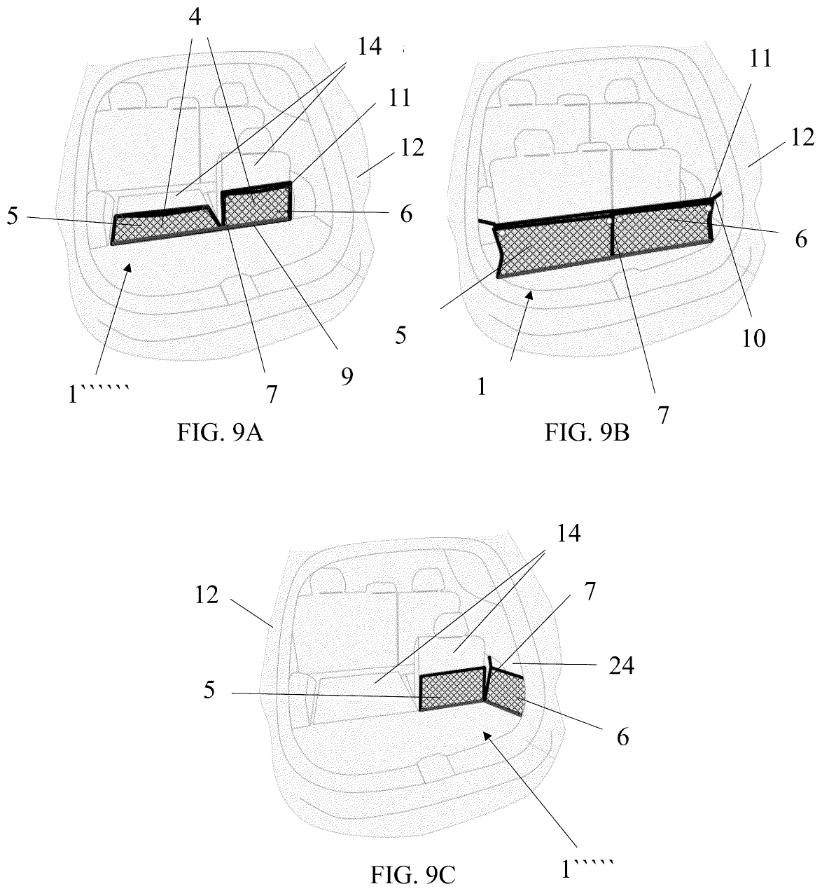

FIGS. 9A-9C depict various configurations of a split edge cargo net 1″″″, according to an exemplary embodiment of the present disclosure. The cargo net 1″″″ may include a flexible netting 4 surrounded by a perimeter cord or band.

Comparted to the cargo net 1 described in FIG. 1, the cargo net 1″″″ may not have the bottom section 8 in FIGS. 9A and 9C. Also, the centerline cord 9 in the cargo net 1 may function as a connecting part 9 that connects the left and right sections 5 and 6. The flexible netting 4 may be substantially vertically divided into the left section 5 and the right section 6, thereby creating split edges 7 for each of the left section 5 and the right section 6 at a location where the sections 5, 6 are divided. Preferably, the flexible netting 4 may be vertically divided into the left section 5 and the right section 6. The left section 5 and the right section 6 may be connected by the connecting part 9 of the perimeter cord or band that runs substantially perpendicularly to the split edges 7. Preferably, the left section 5 and the right section 6 may be connected by the connecting part 9 of the perimeter cord or band that runs perpendicularly to the split edges 7. The left section and the right section may have secondary connectors at each vertex of the perimeter cord or band 3, respectively, except vertexes on the connecting part. The split edges may be configured to be opened and closed by a zipping mechanism such as a zipper. The flexible netting may be substantially vertically divided into multiple sections, thereby creating split edges for each of the multiple sections at a location where the sections are divided. Each of the sections may rotate independently about the centerline corresponding to fixed or movable features, preferably within the cargo space.

As shown in FIG. 9A, the connecting part 9 may engage with a backseat of the seats such as the rear seats 14. In this embodiment, primary connectors may not be necessary for the cargo net 1″″″ to be attached to the seats. The left section 5 and the right section 6 may have the secondary connectors 11 that is engaged with the seats by the secondary connectors 11. Each of the sections 5, 6 may have a pocket-type cargo space.

As shown in FIG. 9B, the left section 5 and the right section 6 of the cargo net 1 may have primary connectors 10 configured to engage with a vehicle 12, or secondary connectors 11 configured to engage with the vehicle 12. The cargo net 1 may be folded to have an envelope type cargo space. At least one of the primary connectors 10 may be in a form of cord configured to engage with the vehicle 12. The cargo net 1 may be hung by the primary connectors 10 that engage with side trim panels of the vehicle 12. At least one of the secondary connectors 11 may be in a form of button configured to be received by a second attachment portion such as a receiver on the vehicle 12. The button may include a post that is configured to be received by a recessed portion of the receiver and a socket that is configured to receive another post. The receiver may be positioned on a back side of the rear seats 14 in the vehicle 12, or an internal wall (e.g., cargo floor, doors, trim panels, etc.) of the vehicle 12. The split edges 7 may be configured to be opened and closed by a zipping mechanism such as a zipper.

As shown in FIG. 9C, at least a part of the connecting part 9 of the cargo net 1″″″ may engage with a seat such as the rear seat 14 in the vehicle or an internal wall 24 of the vehicle 12. Preferably, one split section of the cargo net 1″″″ may be attached to a seat such as the rear seat 14, and the other section along an internal wall, preferably a side wall, 24 of the vehicle 12. It may be also possible to engage the whole connecting part 9 of the cargo net 1″″″ with an internal wall 24 of the vehicle 12. It may be also possible to engage the whole connecting part 9 of the cargo net 1″″″ with a seat such as the rear seat 14 of the vehicle 12. Each of the sections 5, 6 may have a pocket-type cargo space.

In another embodiment, vehicles are provided that comprise an apparatus as disclosed herein.

Although exemplary embodiments of the present disclosure have been described for illustrative purposes, those skilled in the art will appreciate that various modifications, additions, and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A splitable cargo net for a vehicle, the cargo net comprising:
a flexible netting surrounded by a perimeter cord or band; the flexible netting comprising:
a top section substantially vertically divided into a left top section and a right top section, thereby creating split edges for each of the left top section and the right top section at a location where the sections are divided;
a bottom section; and
a centerline cord that runs the cargo net substantially horizontally between the top section and the bottom section.

2. The cargo net of claim 1, wherein the left top section and the right top section have primary connectors configured to engage with a vehicle and secondary connectors configured to engage with the vehicle.

3. The cargo net of claim 2, wherein at least one of the primary connectors are in a form of cord configured to engage with the vehicle.

4. The cargo net of claim 2, wherein at least one of the secondary connectors are in a form of button configured to be received by a receiver on the vehicle.

5. The cargo net of claim 4, wherein the button comprises a post that is configured to be received by a recessed portion of the receiver.

6. The cargo net of claim 4, wherein the receiver is positioned on a back side of a seat in the vehicle or an internal wall of the vehicle.

7. The cargo net of claim 2, wherein the left top section, the right top section and the bottom section have primary connectors at each vertex of the perimeter cord or band, respectively, except vertexes on split edges.

8. The cargo net of claim 2, wherein the left top section, the right top section and the bottom section have secondary connectors at each vertex of the perimeter cord or band, respectively, except vertexes on the centerline cord.

9. The cargo net of claim 1, wherein the split edges are configured to be opened and closed by a zipping mechanism.

10. The cargo net of claim 1, wherein the top section or the bottom section is substantially vertically divided into multiple sections, thereby creating split edges for each of the multiple sections at a location where the sections are divided.

11. A splitable cargo net for a vehicle, the cargo net comprising:
a flexible netting surrounded by a perimeter cord or band,
wherein the flexible netting is substantially vertically divided into a left section and a right section, thereby creating split edges for each of the left section and the right section at a location where the sections are divided, and
wherein the left section and the right section are connected by a connecting part of the perimeter cord or band that runs substantially perpendicularly to the split edges.

12. The cargo net of claim 11, wherein the connecting part is configured to be attached to a seat in the vehicle or an internal wall of a vehicle.

13. The cargo net of claim 12, wherein the left section and the right section have primary connectors configured to engage with a vehicle, or secondary connectors configured to engage with the vehicle.

14. The cargo net of claim 13, wherein at least one of the primary connectors are in a form of cord configured to engage with the vehicle.

15. The cargo net of claim 13, wherein at least one of the secondary connectors are in a form of button configured to be received by a receiver on the vehicle.

16. The cargo net of claim 15, wherein the receiver is positioned on a back side of a seat in the vehicle or an internal wall of the vehicle.

17. The cargo net of claim 13, wherein the left section and the right section have secondary connectors at each vertex of the perimeter cord or band, respectively, except vertexes on the connecting part.

18. The cargo net of claim 11, wherein 1) the split edges are configured to be opened and closed by a zipping mechanism and/or 2) the top section or the bottom section is substantially vertically divided into multiple sections, thereby creating split edges for each of the multiple sections at a location where the sections are divided.

19. A vehicle comprising a cargo net of claim 1.

20. A vehicle comprising a cargo net of claim 11.
